(19) United States
(12) Patent Application Publication
(10) Pub. No.: US 2013/0201156 A1
(43) Pub. Date: Aug. 8, 2013

(54) OPTICAL TOUCH NAVIGATION

(71) Applicants: Carl Picciotto, Redmond,, WA (US); John Lutian, Redmond,, WA (US); Dave Lane, Redmond,, WA (US); Yijing Fu, Redmond,, WA (US)

(72) Inventors: Carl Picciotto, Redmond,, WA (US); John Lutian, Redmond,, WA (US); Dave Lane, Redmond,, WA (US); Yijing Fu, Redmond,, WA (US)

(73) Assignee: MICROSOFT CORPORATION, Redmond, WA (US)

(21) Appl. No.: 13/368,716

(22) Filed: Feb. 8, 2012

(51) Int. Cl. G06F 3/042

(52) U.S. Cl. 345/175

(57) ABSTRACT

The present disclosure describes touch interfaces that feature optical touch navigation. A lighting device distributes a light over an optical element that, in turn, generates a light beam at an exit of the optical element by internally reflecting the light. A sensing device captures images in response to the light beam striking the sensing device. A processing device detects an object proximate to the optical element by comparing successive images captured by the sensing device.

### TECHNICAL FIELD

This disclosure pertains to interactive interfaces and, more particularly, to touch interfaces that feature optical touch navigation.

### BACKGROUND

Touch interfaces permit a user to interact with computing devices by touching a screen with a finger or stylus. Touch interfaces are pervasive, particularly in mobile computing devices. Touch interfaces may be implemented using various technologies, e.g., resistive, capacitive, or optical technologies. Resistive technology-based touch interfaces typically may include two layers coated with a resistive material that are separated by a gap. A different voltage electrifies each of the two layers. A touch by a finger or stylus presses the two layers together, changing the voltage and allowing the interface to identify the location of the touch. Resistive technology-based interfaces are inexpensive to manufacture but suffer from low optical transparency. Resistive technology-based interfaces are susceptible to scratches on the touch surface.

Capacitive technology-based touch interfaces may use a single active layer coated with a transparent conductor. A small current runs across the interface, with circuits located at the corners to measure the capacitance of a finger or a conductive stylus when it touches the interface. The touch of the finger or the conductive stylus draws current from the active layer, changing capacitance and allowing the interface to identify the location of the touch. Capacitive technology-based touch interfaces may determine geometrical features of a contact patch, e.g., centroid and size, to track movement of the finger or conductive stylus. The touch interfaces estimate movement based on the geometrical features of the contact patch as the finger or the conductive stylus moves from one location to another on the touch screen surface. The geometrical features of the contact patch, however, are indirect measurements of the finger or the conductive stylus' position and trajectory, which may lead to position estimation inaccuracies or slop, e.g., retrograde scrolling, where a contact patch is erroneously interpreted as moving backwards even as the user extends his finger forward.

Optical technology-based touch interfaces rely on optics to detect light emission or reflections from touch that translate into movement of a cursor or other icon on a screen or monitor. Optical touch interfaces have been found useful for applications in which little physical space or area exists for a larger capacitive or resistive touch interfaces. For example, optical touch interfaces are common in computer mice. Small area optical touch interfaces such as those implemented in mice are not generally considered ideal for the long distance precision control necessary for scrolling or panning since these actions would require multiple swipes of the touch interface to scroll or pan through an entire page.

Consumer products manufacturers often seek touch interfaces that may address some of the disadvantages associated with resistive, capacitive, or optical touch interfaces.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An exemplary touch interface includes a lighting device, an optical device, and a sensing device. The lighting device distributes light over at least one surface of the optical device which, in turn, generates a light beam at an exit of the optical device by internally reflecting the light in the optical device. The sensing device detects an object incident on or proximate to the optical device by comparing successive images of the object captured by the sensing device in response to the light beam striking the sensing device. The lighting device may include a light source and a backlight device configured to project the light generated by the light source onto at least one surface of the optical device. The optical device may comprise an optical wedge including a thick end opposing a thin end. The optical wedge internally may reflect the light between a top surface and a bottom surface of the optical wedge and may produce the light beam at the thick end.

Additional aspects and advantages of exemplary touch devices including optical touch navigation will be apparent from the following detailed description that proceeds with reference to the accompanying drawings.

### DRAWINGS DESCRIPTION

FIG. 1A is a sectional view of an exemplary touch interface.

FIG. 1B is a sectional view of an exemplary optical device shown in FIG. 1A including ray traces.

FIG. 1C is a top view of an exemplary optical device shown in FIG. 1A including ray traces.

FIG. 1D is a sectional view of an exemplary touch interface.

FIG. 1E is an image of an object incident on or proximate to an exemplary touch interface.

FIG. 2 is a sectional view of an exemplary backlight device.

FIG. 3 is a block diagram illustrating the noise terms in the exemplary touch interface shown in FIGS. 1A-1D.

FIG. 4 is a flowchart of an exemplary method associated with the touch interface shown in FIGS. 1A-1D.

FIG. 5 is a block diagram of an exemplary system for implementing the touch interface shown in FIGS. 1A-1D.

### DETAILED DESCRIPTION

An exemplary optical touch interface described herein is useful in applications where precision control is necessary, e.g., for scrolling or panning, which require tracking of one or more objects over larger distances than those afforded by known optical finger navigation devices such as optical touch mice. Note that the optical touch interface directly tracks movement of at least one object incident on a surface of an optical device, which increases tracking precision. The larger distance optical tracking is possible due at least in part to the optical device, which generates a light beam by internally reflecting the light. The internal light reflection, in turn, allows for a reduction in a size of an optical path necessary for such larger distance optical tracking. The reduction in the size of the optical path provides greater design freedom with regard to the touch interface's angles and contours. A sensing device captures an image of a surface of the optical device in response to the light beam striking the sensing device. The sensing device detects one or more objects incident on the optical device by comparing successively captured images of the light beam at the exit of the optical device since the object(s) will scatter at least a portion of the light internally reflected by the optical device.

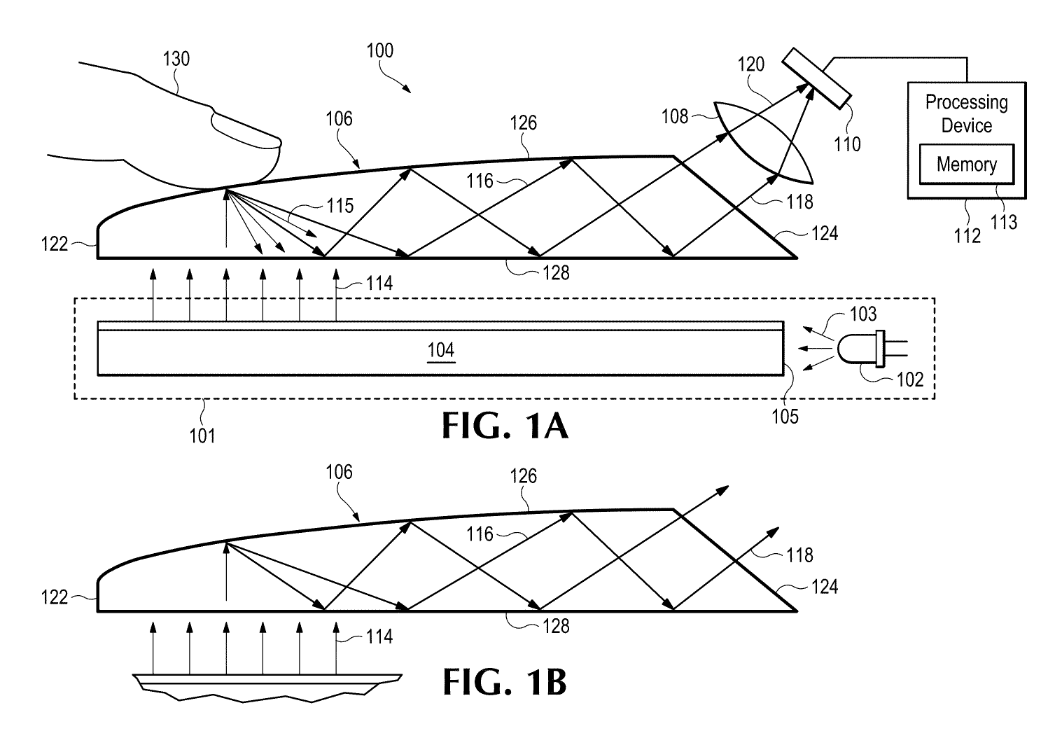

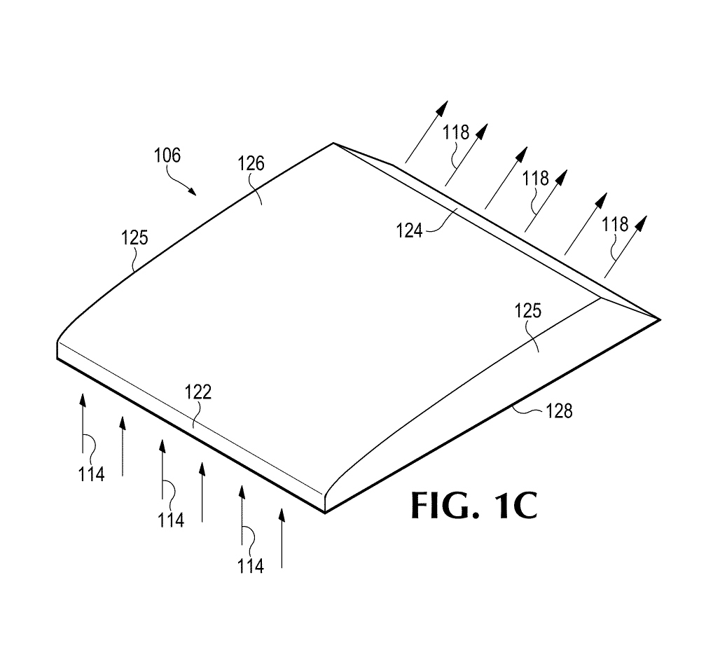

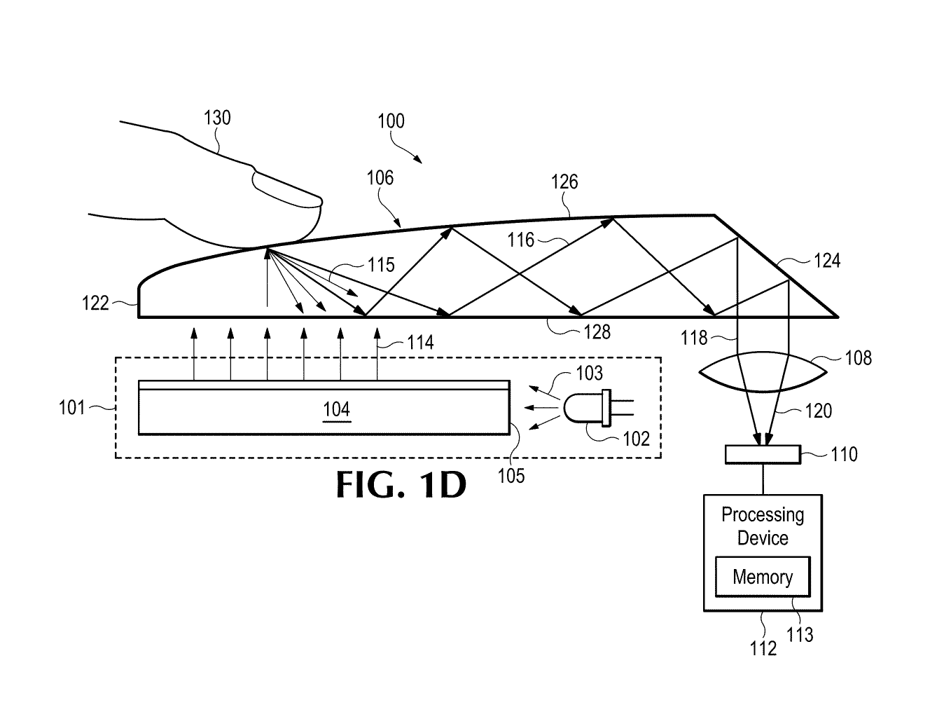

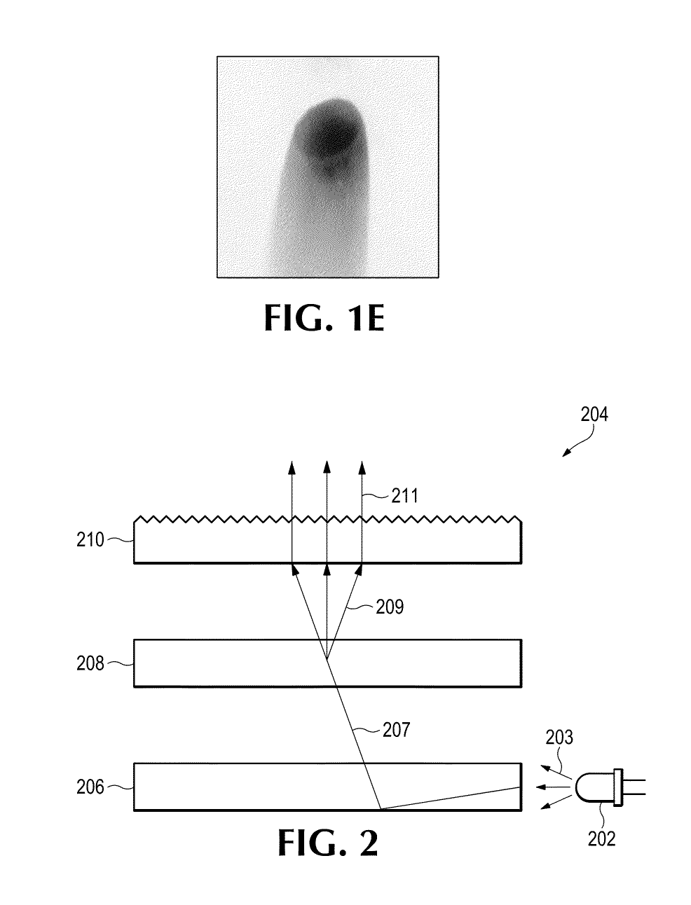

Referring to FIGS. 1A-1D, touch interface 100 may be configured to detect object 130 incident on or proximate to top surface 126 of optical device 106 by capturing images of object 130 on top surface 126. Touch interface 100 may track movement of object 130 across top surface 126 by comparing captured images in response to movement of object 130 on top surface 126. Accordingly, touch interface 100 may be configured to illuminate object 130 and to detect the light reflected from object 130 using sensor 110. In this manner, touch interface 100 may register positions of the object as it moves on top surface 126 of optical device 106. Touch interface 100 may be configured to substantially simultaneously detect multiple objects 130, e.g., multiple touches of a user's finger, incident on or proximate to top surface 126 of optical device 106. For simplicity, however, object 130 is described below in the singular.

Touch interface 100 may include a lighting device 101, which, in turn, may include light source 102 and backlight device 104. Light source 102 may source light 103 while backlight device 104 may project light 103 onto optical device 106. Light source 102 may be any illuminant configured to emit or source any kind of light known to a person of ordinary skill in the art including structured, unstructured, single wavelength, visible, or infrared light. An exemplary light source 102 may include at least one light emitting diode positioned adjacent to end 105 of backlight device 104. Another exemplary light source 102 may include a plurality of light emitting diodes positioned along and adjacent to end 105 of backlight device 104. The plurality of light emitting diodes may increase the intensity of rays 114 distributed to optical device 106 by backlight device 104.

Backlight device 104 projects or otherwise distributes light 103 from light source 102 as rays 114 onto optical device 106. A portion of light 103 may leak out along a length of backlight device 104, e.g., due to diffusing elements shown in FIG. 2. An exemplary backlight device 104 may be positioned under optical device 106 to project light 103 onto bottom surface 128. Backlight device 104 may extend across a portion or an entire two-dimensional area of optical device 106. In an embodiment, backlight device 104 extends under a portion of the optical device 106 that will be touch-sensitive. Backlight device 104 may comprise several elements or layers depending on a variety of factors including physical dimensions, electronic or optical design constraints, performance, cost, or other guidelines as is known to a person of ordinary skill in the art. Backlight device 104 may comprise any material known to a person of ordinary skill in the art for use in optical applications, including transparent plastic, transparent glass, polycarbonate material, acrylic material, and the like.

Referring to FIG. 2, an exemplary backlight device 204 may comprise light source 202 that may illuminate light guide 206 with light 203. An exemplary light source 202 may comprise a light emitting diode, a plurality of light emitting diodes, lamp, or any other illuminant configured to emit or source any kind of light known to a person of ordinary skill in the art including structured, unstructured, single wavelength, visible, or infrared light. Light 203 may enter light guide 206 for distribution along its length. At least a portion of light 203 may be reflected as rays 207 in response to light guide 206. Diffuser 208 may spread or scatter rays 207 to produce diffused rays 209. Film 210, in turn, may further optimize diffused rays 209 by producing rays 211 that avoid unintentional light scatter and enable a greater amount of light 203 to reach optical device 106 (FIG. 1). The design and operation of backlight device 204 including light guide 206, diffuser 208, and film 210 is known to a person of ordinary skill in the art. Backlight device 204 including light guide 206, diffuser 208, and film 210 may comprise materials and design constraints suitable to their function as is known to a person of ordinary skill in the art.

Referring back to FIGS. 1A-1D, optical device 106 may comprise a substantially two-dimensional wedge-shaped light guide otherwise known as an optical wedge. An optical wedge is a light guide that conducts or aligns light via total internal reflection to produce a light beam 118 comprising substantially parallel light rays at an exit. An exemplary optical device 106 may allow light 103 to be distributed from light source 102 to thick end 124, where light beam 118 exits. Such optical wedges may find various uses, including but not limited to as a light guide as described herein. Optical device 106 may be bounded by top surface 126 and bottom surface 128 as well opposing sides 125, thin end 122, and thick end 124. Optical device 106 may comprise any material known to a person of ordinary skill in the art for use in optical applications, including transparent plastic, transparent glass, polycarbonate material, acrylic material, and the like.

Optical device 106 may extend over a portion or an entire length of backlight device 104. Rays 114 may enter optical device 106 from bottom surface 128 at any angle, including a view angle greater than or equal to zero degrees. Optical device 106 may distribute rays 114 through internal reflection as reflected rays 116. Reflected rays 116 may reflect internally between top surface 126 and bottom surface 128 before exiting at thick end 124 to be delivered as light beam 118 to lens 108 and sensor 110. A portion of reflected rays 116 may exit top surface 126. In this manner, optical device 106 de-magnifies, focuses, or otherwise directs light 103 delivered from light source 102 to sensor 110 through optical device 106 bounded by top surface 126, bottom surface 128, opposing sides 125, thin end 122, and thick end 124. In an embodiment, light beam 118 may comprise substantially collimated or parallel rays.

FIG. 1D is a side view of an exemplary touch interface 100 in which thick end 124 is coated with a reflective material. Rays 114 may enter optical device 106 from bottom surface 128 to be internally reflected as rays 116 between top surface 126 and bottom surface 128 along a horizontal length of optical device 106. Reflected rays 116 are redirected or reflected by reflective thick end 124 to exit downward through bottom surface 128 as light beam 118 to lens 108 and sensor 110.

Sensor 110, in turn, senses light beam 118 to capture images of top surface 126 or an object 130 proximate to or incident on top surface 126 as reflected rays 116 traverse optical device 106. Sensor 110 may be any kind of device that captures light and converts the captured light into an electronic signal, e.g., charge-coupled devices (CCDs), complementary metal-oxide-semiconductor (CMOS) sensors, and active pixel arrays. Sensor 110 may include an analog portion and a digital portion (not shown separately from sensor 110). The analog portion may include a photo sensor that holds an electrical charge representative of the light striking its surface and converts the charge into a voltage one pixel at a time. The digital portion (not shown separately from sensor 110) may convert the voltage into a digital signal representative of the light striking the photo sensor. Sensor 110 may be an integrated circuit that includes both the analog portion and the digital portion. Alternatively, sensor 110 may comprise two distinct circuits separately implementing the analog portion and the digital portion. Sensor 110 may alternatively be integrated with processing device 112 to include additional features described in more detail herein.

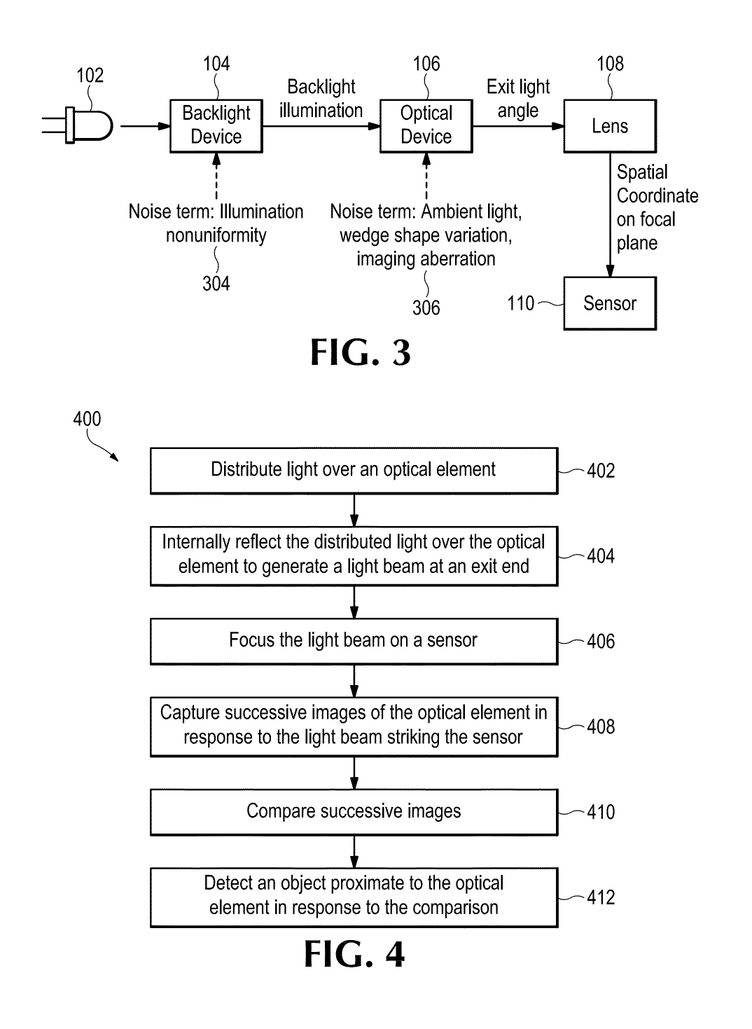

In an embodiment, lens 108 may be interposed between thick end 124 and sensor 110 to focus the light beam 118 exiting thick end 124 onto sensor 110. In another embodiment, lens 108 may be interposed between bottom surface 128 and sensor 110 to focus the light beam 118 exiting bottom surface 128 onto sensor 110. Lens 108 may be any device known to a person of ordinary skill in the art capable of focusing light beam 118 on sensor 110 and capable of compensating for optical aberrations that may occur in optical device 106. In this context, an optical aberration may be any deviation of the actual image from the ideal image of object 130 that may occur due to, e.g., optical device shape variation, imaging aberrations, and the like (FIG. 3). Lens 108 may comprise any material known to a person of ordinary skill in the art for use in optical applications, including transparent plastic, transparent glass, polycarbonate material, acrylic material, and the like.

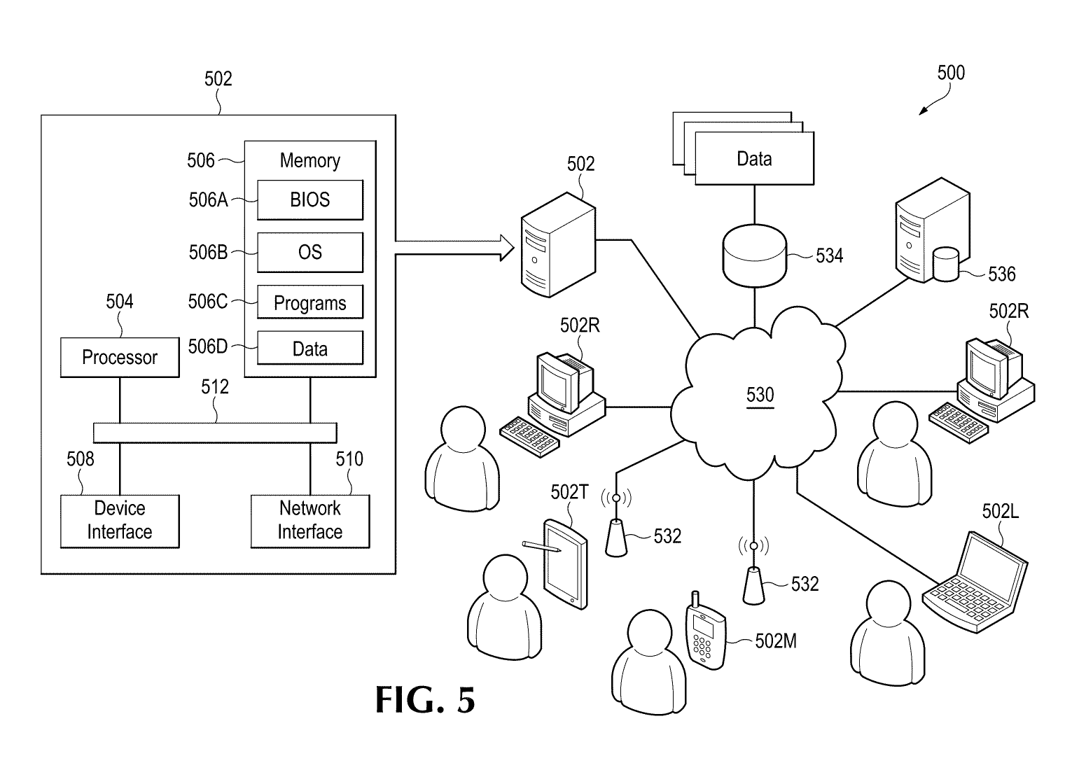

Processing device 112 may include any processor capable of manipulating or otherwise processing an output of sensor 110. Processing device 112 may include memory 113, which may be of any type or of any size known to a person of ordinary skill in the art. An embodiment of processing device 112 and memory 113 may include processor 504 and memory 506 shown in FIG. 5.

Object 130 proximate to or incident on optical device 106 may scatter at least a portion of the reflected rays 116 as scattered rays 115. An angle at which at least a portion of the reflected rays 116 and scattered rays 115 exit the thick end 124 as light beam 118, therefore, may change according to a position of object 130 on top surface 126. Sensor 110 may capture images of object 130 proximate to or incident on top surface 126 at predetermined times and store the images in onboard memory (not shown separately from sensor 110). Alternatively, sensor 110 may transmit the images to processing device 112 for storage in memory 113 and subsequent processing. Processing device 112 may compare successively captured images or may compare images captured at predetermined intervals to determine a location of object 130 on top surface 126 and to directly track movement of object 130 on top surface 126. Note that positions of object 130 on top surface 126 are directly determined or tracked by processing device 112 from a comparison of the images, and not indirectly from other indicia, e.g., contact patch geometries, as is the case with other touch technologies. Processing device 112 may compare successively captured images using any number of algorithms, including cross-correlation algorithms or single or multi contact tracking algorithms as is well known to a person of ordinary skill in the art.

FIG. 1E is an exemplary image of an object 130 incident on or proximate to top surface 126 on touch interface 100 as captured when light beam 118 strikes the sensor 110.

Referring to FIG. 3, backlight device 104 may need to compensate for non-uniform illumination 304 from light source 102 due to, e.g., electrical specifications or physical positioning limitations. Optical device 106, lens 108, or sensor 110 may need to compensate for ambient light, optical device shape variations due to manufacturing limitations or irregularities, and imaging aberrations 306.

Referring to FIGS. 1A-1D and 4, an exemplary method 400 includes a light source 102 and backlight device 104 that distribute light 103 over optical device 106 as rays 114 (at 402). At 404, optical device 106 internally reflects rays 114 as reflected rays 116 to thereby generate light beam 118 that exit the optical device 106 at thick end 124 or bottom surface 128. At 406, lens 108 focuses light beam 118 onto sensor 110, which, in turn, captures images of object 130 proximate to or incident on top surface 126 as beam 118 strikes sensor 110 (at 408). At 410, processing device 112 stores the captured images and compares images. At 412, processing device 112 detects object 130 proximate to or incident on the optical element 106 in response to the comparison at 410.

Referring to FIG. 5, system 500 may include a computing device 502 that may execute instructions of application programs or modules 506C stored in system memory, e.g., memory device 506. Application programs or modules 506C may include objects, components, routines, programs, instructions, data structures, and the like that perform particular tasks or functions or that implement particular abstract data types. Some or all of application programs 506C may be instantiated at run time by processing device 504. A person of ordinary skill in the art readily will recognize that many of the concepts associated with system 500 may be implemented as computer instructions, firmware, or software in any of a variety of computing architectures, e.g., computing device 502, to achieve a same or equivalent result.

Moreover, a person of ordinary skill in the art readily will recognize that system 500 may be implemented on other types of computing architectures, e.g., general purpose or personal computers, hand-held devices, mobile communication devices, multi-processor systems, microprocessor-based or programmable consumer electronics, minicomputers, mainframe computers, application specific integrated circuits, System-On-Chip (SOC), and like. For illustrative purposes only, system 500 is shown in FIG. 5 to include computing devices 502, geographically remote computing devices 502R, tablet computing device 502T, mobile computing device 502M, and laptop computing device 502L.

Similarly, a person of ordinary skill in the art readily will recognize that system 500 may be implemented in a distributed computing system in which various computing entities or devices, often geographically remote from one another, e.g., computing device 502 and remote computing device 502R, perform particular tasks or execute particular objects, components, routines, programs, instructions, data structures, and the like. For example, system 500 may be implemented in a server/client configuration (e.g., computing device 502 may operate as a server and remote computing device 502R, tablet computing device 502T, mobile computing device 502M, or laptop computing device 502L may operate as clients). In system 500, application programs 506C may be stored in local memory device 506, external memory device 536, or remote memory device 534. Local memory device 506, external memory device 536, or remote memory device 534 may be any kind of memory known to a person of ordinary skill in the art including random access memory (RAM), flash memory, read only memory (ROM), ferroelectric RAM, magnetic storage devices, optical discs, and the like.

Computing device 502 may comprise processing device 504, memory device 506, device interface 508, and network interface 510, which all may be interconnected through bus 512. Processing device 504 may represent a single, central processing unit, or a plurality of processing units in a single computing device 502 or plural computing devices, e.g., computing device 502 and remote computing device 502R. Local memory device 506, external memory device 536, and/or remote memory device 534 may be any type of memory device, such as any combination of RAM, flash memory, ROM, ferroelectric RAM, magnetic storage devices, optical discs, and the like. Local memory device 506 may include a basic input/output system (BIOS) 506A with routines to transfer data, including data 506D, between the various elements of system 500. Local memory device 506 also may store an operating system (OS) 506B that, after being initially loaded by a boot program, manages other programs in computing device 502. Local memory device 506 may store routines or programs 506C designed to perform a specific function for a user or another application program, e.g., application programs configured to capture images from sensor or application programs configured to compare successively captured images to detect an object incident over an optical element, which we describe in more detail above. Local memory device 506 additionally may store any kind of data 506D, e.g., images from sensor 110 (FIG. 1A).

Computing device 502 may comprise processing device 112 and memory 113 of touch interface 100, shown in FIG. 1A. Alternatively, processing device 112 and memory 113 may be implemented in one or more devices distinct from computing device 502.

Device interface 508 may be any one of several types of interfaces. Device interface 508 may operatively couple any of a variety of devices, e.g., hard disk drive, optical disk drive, magnetic disk drive, or the like, to bus 512. Device interface 508 may represent either one interface or various distinct interfaces, each specially constructed to support the particular device that it interfaces to bus 512. Device interface 508 may additionally interface input or output devices utilized by a user to provide direction to computing device 502 and to receive information from computing device 502. These input or output devices may include keyboards, monitors, mice, pointing devices, speakers, stylus, microphone, joystick, game pad, satellite dish, printer, scanner, camera, video equipment, modem, monitor, and the like. Device interface 508 may interface with touch devices, optical or otherwise, including optical touch interface 100 shown in FIGS. 1A-1D. Device interface 508 may be a serial interface, parallel port, game port, firewire port, universal serial bus, or the like.

A person of skill in the art readily will recognize that system 500 may comprise any type of computer readable medium accessible by a computer, such as magnetic cassettes, flash memory cards, digital video disks, cartridges, RAM, ROM, flash memory, magnetic disc drives, optical disc drives, and the like.

Network interface 510 may operatively couple computing device 502 to remote computing devices 502R, tablet computing devices 502T, mobile computing devices 502M, and/or laptop computing devices 502L, on network 530. Network 530 may be a local, wide area, or wireless network, or any other type of network capable of electronically coupling one computing device to another computing device. Computing devices 502R may be geographically remote from computing device 502. Remote computing device 502R may have a structure corresponding to computing device 502, or may operate as a server, client, router, switch, peer device, network node, or other networked device and may include some or all of the elements of computing device 502. Computing device 502 may connect to the local or wide area network 530 through a network interface 510 or adapter included in interface 560, may connect to the local or wide area network 530 through a modem or other communications device included in the network interface 510, may connect to the local or wide area network 530 using a wireless device 532, or the like. Modem or other communication devices may establish communications to remote computing devices 502R through global communications network 530. A person of ordinary skill in the art readily will recognize that application programs or modules 506C may be stored remotely through such networked connections.

A person of ordinary skill in the art will recognize that they may make many changes to the details of the above-described exemplary touch interfaces that feature optical touch navigation without departing from the underlying principles. Only the following claims, therefore, define the scope of the exemplary touch interfaces that feature optical touch navigation.

1. An apparatus, comprising:
a lighting device;
an optical device configured to generate a light beam at an exit of the optical device by internally reflecting light distributed by the lighting device over a bottom surface of the optical device;
a sensing device configured to capture images of a top surface of the optical device in response to the light beam at the exit end of the optical device striking the sensing device; and
a processing device configured to detect an object proximate to the top surface of the optical device by comparing successive images captured by the sensing device.

2. The apparatus of claim 1, wherein the lighting device comprises:
a light source configured to source the light; and
a backlight device configured to distribute the light over the bottom surface of the optical device.

3. The apparatus of claim 2, wherein the light source is disposed at an end of the backlight device.

4. The apparatus of claim 2, wherein the light source comprises at least one light emitting diode.

5. The apparatus of claim 2,
wherein the optical device comprises an optical wedge with a thin end opposing a thick end; and
wherein the light beam is configured to exit the thick end of the optical wedge.

6. The apparatus of claim 5, wherein the backlight device is configured to backlight the optical wedge from a position under the optical wedge.

7. The apparatus of claim 6, wherein the optical wedge is configured to internally reflect the light substantially between a top surface and a bottom surface of the optical wedge.

8. The apparatus of claim 7, wherein the optical wedge is configured to focus the light distributed by the lighting device over the bottom surface of the optical wedge to deliver the light beam to the sensing device.

9. The apparatus of claim 1, further comprising an imaging lens disposed between the optical device and the sensing device and configured to focus the light beam on the sensing device.

10. The apparatus of claim 1, wherein the light beam comprises rays having an exit angle that correspond to a position of the object proximate to the top surface of the optical device.

11. A method, comprising:
distributing light over an optical element;
internally reflecting the light over the optical element to generate a light beam at an exit of the optical element;
capturing images of an object proximate to a surface of the optical element using a sensor in response to the light beam striking the sensor; and
tracking the object on the surface of the optical element by comparing successively captured images of the object.

12. The method of claim 11, wherein distributing the light over the optical element further comprises backlighting the optical element.

13. The method of claim 11, wherein distributing the light over the optical element further comprises illuminating a backlight device disposed under the optical element with a light source.

14. The method of claim 11,
wherein distributing the light over the optical element further comprises distributing the light over an optical wedge; and
wherein internally reflecting the light over the optical element further comprises internally reflecting the light using a top surface and a bottom surface of the optical wedge such that the light beam exits a thick end of the optical wedge opposing a thin end of the optical wedge.

15. The method of claim 14, further comprising:
interposing a lens between the optical element and the sensor; and
focusing the light beam on the sensor using the lens.

16. The method of claim 11, wherein the object scatters at least a portion of the light internally reflected by the optical element in response to the object being proximate to the optical element.

17. The method of claim 11, wherein at least a portion of the light beam at the exit of the optical element comprises an angle that corresponds to a position on a top surface of the optical element.

18. A device, comprising:
means for lighting an optical element with light, wherein the optical element comprises a wedge shape having a thin end opposing a thick end;
means for internally reflecting the light to generate a light beam at the thick end of the optical element;
means for capturing images of at least one surface of the optical element in response to the light beam generated at the thick end of the optical element striking the means for capturing images; and
means for detecting an object proximate to the optical element by comparing successively captured images.

19. The device of claim 18, further comprising means for detecting a scattering of at least a portion of the light over the optical element in response to the object being proximate to the optical element.

20. The device of claim 18, wherein the light beam comprises rays having an exit angle that corresponds to a position of the object on the at least one surface of the optical element.
